(19) United States
(12) Patent Application Publication
(10) Pub. No.: US 2008/0136148 A1
(43) Pub. Date: Jun. 12, 2008

(54) Inflatable curtain with integral shield

(75) Inventor: Kevin J. Boxey, Columbiaville, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/637,349

(22) Filed: Dec. 12, 2006

(51) Int. Cl. B60R 21/21

(52) U.S. Cl. 280/730.2

(57) ABSTRACT

An inflatable vehicle occupant protection device (14) includes a main portion (80) defining an inflatable volume (60) and a shield portion (100) defining a shield chamber (102). The inflatable volume (60) and shield chamber (102) are in fluid communication with each other. The shield portion (100) is turned inside-out, positioned in the inflatable volume (60), and configured to receive inflation fluid from an inflation fluid source (24). The shield portion (100) is further configured to rupture and release inflation fluid into the inflatable volume (60) of the main portion (100).

### FIELD OF THE INVENTION

The present invention relates to an apparatus for helping to protect an occupant of a vehicle. More particularly, the present invention relates to an inflatable vehicle occupant protection device with an integrally formed inflation fluid shield.

### BACKGROUND OF THE INVENTION

It is known to inflate an inflatable vehicle occupant protection device to help protect a vehicle occupant. One particular type of inflatable vehicle occupant protection device is an inflatable curtain that inflates away from the roof of the vehicle in a downward direction and inside the passenger compartment between a vehicle occupant and the side structure of the vehicle. A known inflatable curtain is inflated from a deflated condition by inflation fluid directed from an inflator to the inflatable curtain.

### SUMMARY OF THE INVENTION

The present invention relates to an inflatable vehicle occupant protection device. The protection device includes a main portion defining an inflatable volume and a shield portion defining a shield chamber. The inflatable volume and shield chamber are in fluid communication with each other. The shield portion is turned inside-out, positioned in the inflatable volume, and configured to receive inflation fluid from an inflation fluid source. The shield portion is further configured to rupture and release inflation fluid into the inflatable volume of the main portion.

The present invention also relates to an apparatus for helping to protect an occupant of a vehicle having a side structure and a roof. The apparatus includes an inflatable vehicle occupant protection device inflatable away from the vehicle roof between the side structure of the vehicle and a vehicle occupant. The protection device includes a main portion defining an inflatable volume and a shield portion defining a shield chamber. The inflatable volume and shield chamber are in fluid communication with each other. The shield portion is turned inside-out, positioned in the inflatable volume, and configured to receive inflation fluid from an inflation fluid source. The shield portion receives and helps absorb forces from the initial discharge of inflation fluid into the protection device.

The present invention further relates to a one piece woven inflatable vehicle occupant protection device. The protection device includes a main portion defining an inflatable volume, a shield portion defining a shield chamber, and a neck portion providing fluid communication between the inflatable volume and the shield chamber. The shield portion is turned inside-out through the neck portion and positioned in the inflatable volume. The shield portion is configured to receive inflation fluid from an inflation fluid source and to rupture and release inflation fluid into the inflatable volume of the main portion.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping protect an occupant of a vehicle, illustrating the apparatus in a deflated condition;

FIG. 2 is a schematic view of the apparatus of FIG. 1 in an inflated condition;

FIG. 3 is a plan view illustrating a portion of the apparatus of FIG. 1 in a pre-assembled condition;

FIG. 4 is a sectional view illustrating the portion of the apparatus of FIG. 3 in a condition ready for assembly;

FIG. 5 is a sectional view illustrating the apparatus in an assembled condition; and

FIG. 6 is a sectional view illustrating actuation of the apparatus of FIG. 5.

### DESCRIPTION OF THE PREFERRED EMBODIMENTS

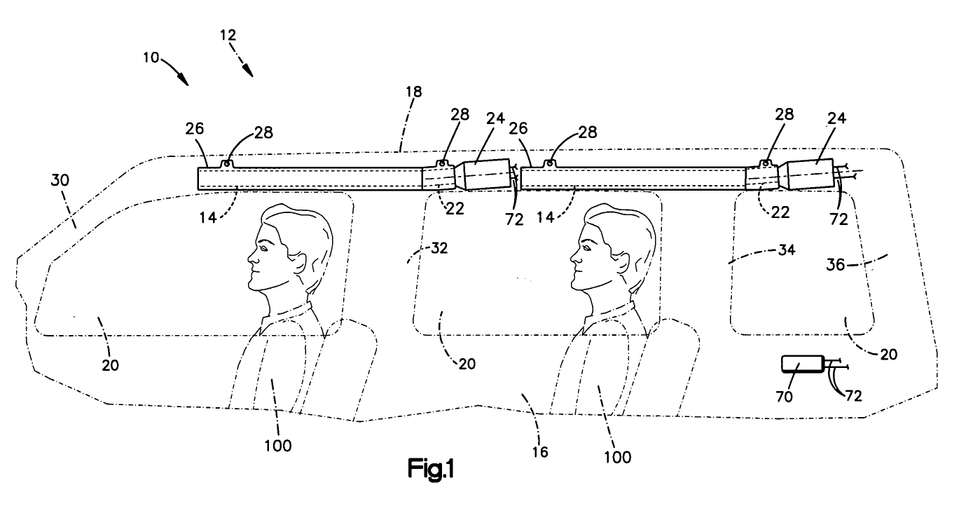

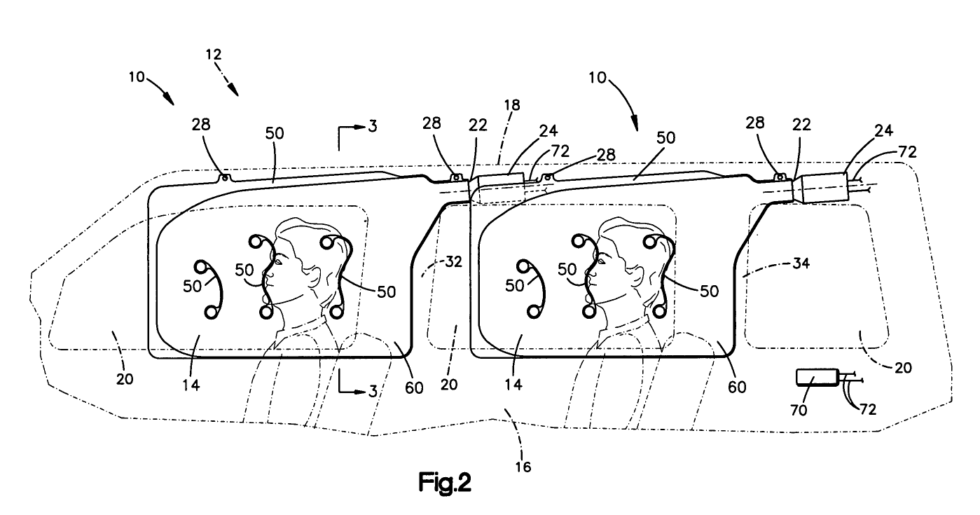

An apparatus 10 helps to protect one or more occupants 100 of a vehicle 12. As shown in FIGS. 1 and 2, the apparatus 10 includes an inflatable vehicle occupant protection device in the form of an inflatable curtain 14. The present invention may include an inflatable vehicle occupant protection device in an alternative form, such as a driver front impact air bag, passenger front impact air bag, side impact air bag, or inflatable knee bolster.

In the embodiment illustrated in FIGS. 1 and 2, the vehicle 12 is outfitted with two apparatus 10 and thus includes two inflatable curtains 14. The inflatable curtains 14 are mounted adjacent a side structure 16 of the vehicle 12 and a roof 18 of the vehicle. The side structure 16 of the vehicle 12 includes side windows 20, an A pillar 30, a B pillar 32, a C pillar 34, and a D pillar 36. In the illustrated embodiment, one inflatable curtain 14 extends between the A pillar 30 and B pillar 32 and thus helps protect a first row occupant 100. One inflatable curtain 14 extends between the B pillar 32 and C pillar 34 and thus helps protect a second row occupant 100. The configuration of the inflatable curtains 14, the vehicle 12, or both could, however, vary. For example, a single inflatable curtain (not shown) could extend from adjacent or near the A pillar 30 to adjacent or near the C pillar 34 to help protect the first and second row occupants 100.

The apparatus 10 includes an inflator 24 connected in fluid communication with the inflatable curtain 14 through a connection port 22 of the curtain. The inflator 24 contains a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 includes a housing 26 (FIG. 1) that stores the inflatable curtain 14 in a deflated condition. The deflated inflatable curtain 14 and the housing 26 have an elongated configuration and extend along the vehicle roof 18 and along the side structure 16 of the vehicle 12 above the side windows 20. The inflatable curtain 14 and housing 26 are connected to the vehicle 12 by means 28, such as fasteners.

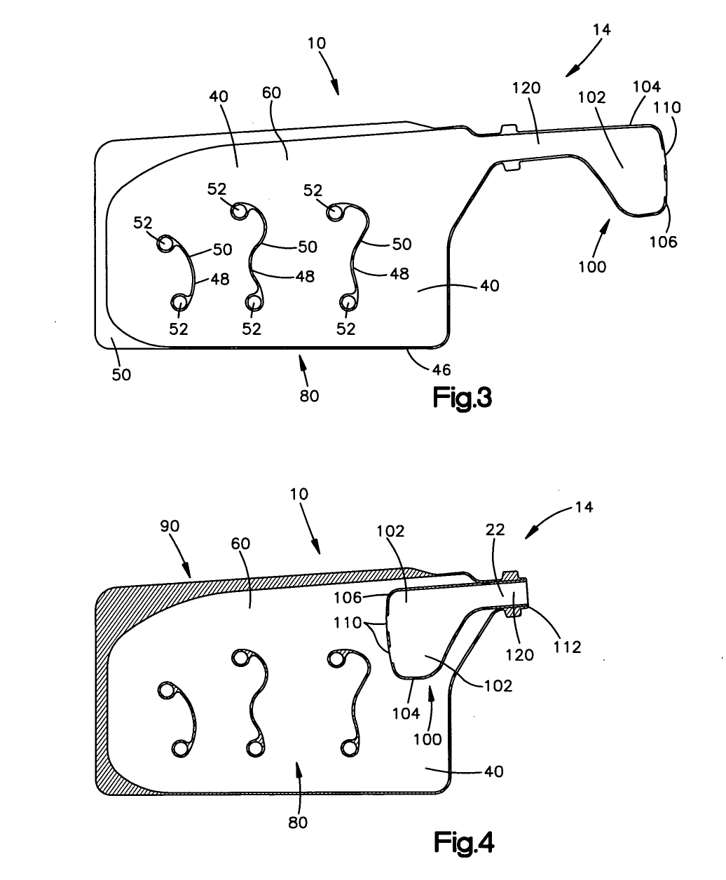

In the illustrated embodiment, the inflatable curtain 14 has a one piece woven (OPW) construction. This construction may be achieved using known weaving processes on known weaving machines, such as a Jacquard loom. Referring to FIG. 3, the OPW inflatable curtain 14 comprises (a) overlying panels 40 woven as separate layers of material and (b) single layers of material 50 that define the periphery of the overlying panels. The single layers 50 include a single layer 46 that extends along at least a portion of an outer edge of the inflatable curtain 14. The single layers 50 may also include single layers 48 spaced from the outer edge of the inflatable curtain 14.

The single layers 50 help define an inflatable volume 60 of the inflatable curtains 14. The single layers 50 may also help define inflatable chambers within the inflatable volume 60. The single layers 48 may also form non-inflatable portions of the inflatable curtain 14 positioned within the inflatable volume 60. For example, in the embodiment illustrated in FIG. 3, the single layers 48 help define non-inflatable portions 52 of the inflatable curtain 14.

The inflatable curtain 14 may be woven from any desired material, such as nylon yarn. The inflatable curtain 14 may be uncoated, coated with a material, such as a gas impermeable urethane, or laminated with a material, such as a gas impermeable film. The inflatable curtain 14 thus may have a gas-tight or substantially gas-tight construction. Those skilled in the art will appreciate that alternative materials, such as silicone, may also be used to coat or laminate the inflatable curtain 14.

The vehicle 12 includes a sensor (shown schematically at 70 in FIGS. 1 and 2) for sensing the occurrence of an event for which inflation of the inflatable curtain 14 is desired, such as a side impact, a vehicle rollover, or both. Upon sensing such an event, the sensor 70 provides an electrical signal over lead wires 72 to the inflator 24. The electrical signal causes the inflator 24 to be actuated in a known manner. The inflator 24 discharges fluid under pressure through the connection port 22, which directs the fluid into the inflatable curtain 14.

The inflatable curtain 14 inflates under the pressure of the inflation fluid from the inflator 24. The housing 26 (FIG. 1) opens, and the inflatable curtain 14 inflates away from the roof 18 in a downward direction as shown in the drawings and in a downward direction with respect to the direction of forward vehicle travel into the position illustrated in FIGS. 2 and 3. The inflatable curtain 14, when inflated, is positioned between the side structure 16 of the vehicle 12 and the occupants 100 of the vehicle. The inflatable curtain 14, when inflated, helps absorb the energy of impacts and helps distribute the impact energy over a large area of the curtain.

Referring to FIG. 3, the inflatable curtain 14 includes a main portion 80, a shield portion 100, and a neck portion 120 that connects the main portion and shield portion. The main portion 80 includes the inflatable volume 60 of the curtain 14. When the inflatable curtain 14 is initially constructed or woven, the shield portion 100 is positioned outside the inflatable volume 60, in fluid communication with the inflatable volume via the neck portion 120. In a finished condition of the inflatable curtain 14 shown in FIG. 4, the shield portion 100 is turned inside-out or turned in through the neck portion 120 and positioned in the inflatable volume 60 of the curtain. This may be achieved, for example, by using a push stick (not shown) to push the shield portion into the main portion 80. As a result, the neck portion 120 is doubled over, forming the connection port 22 and giving the connection port a double-layered configuration. A terminal end fold 112 is formed where the shield portion 100 is turned inside-out into the main portion 80.

The shield portion 100 defines a shield chamber 102 positioned in the inflatable volume 60 of the inflatable curtain 14. The shield chamber 102 is in fluid communication with the connection port 22. The shield portion 100 includes a side wall 104 defined by a portion of the single layers 46 that extends along the outer edge of the inflatable curtain 14. The side wall 104 includes an end wall 106 positioned opposite the connection port 22. The end wall 106 includes one or more tear seams 110.

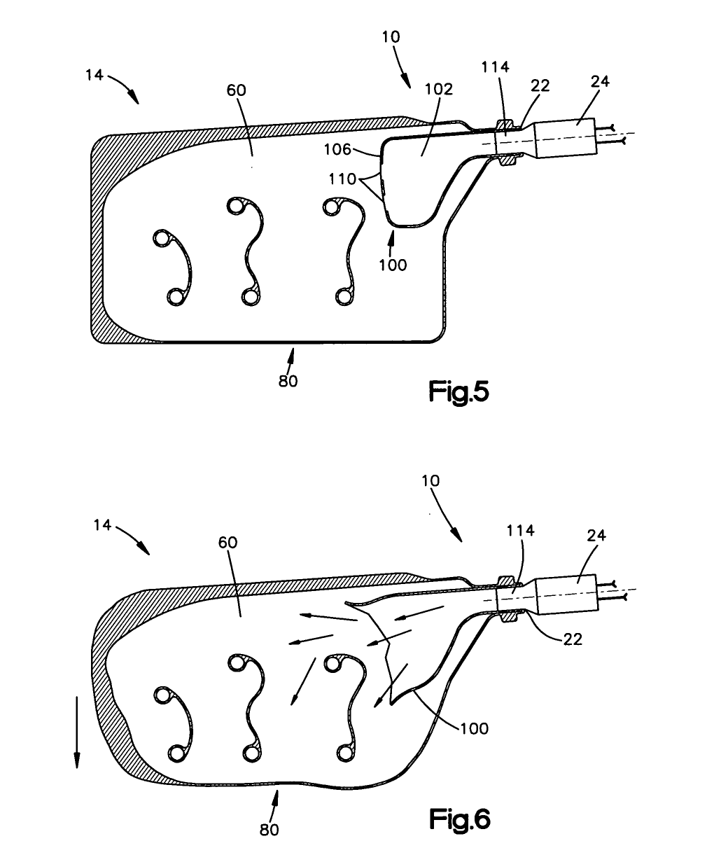

FIG. 5 illustrates the inflatable curtain 14 of FIG. 4 assembled with the inflator 24. In this assembled condition, an outlet portion 114 of the inflator 24 is positioned in the connection port 22. Means (not shown), such as a clamp, secures the connection port 22 to the outlet portion 114.

The inflator 24, when actuated, discharges inflation fluid from the outlet portion 114 into the shield chamber 102 via the connection port 22. The shield portion 100 inflates and pressurizes. When a predetermined force is applied to the tear seams 110, e.g., through pressurization of the shield chamber 102, through the force of inflation fluid directed against the tear seams, or both, the tear seams rupture. This is shown in FIG. 6. When the tear seams 110 rupture, inflation fluid is directed into the inflatable volume 60 of the inflatable curtain 14 and the curtain inflates and deploys as described above.

It will thus be appreciated that the shield portion 100 bears the forces generated when the inflator 24 initially discharges inflation fluid into the inflatable curtain. The breaking or tear strength of the tear seams 110 is tailored such that the shield portion 100 does not substantially inhibit inflation and deployment of the inflatable curtain 14. Advantageously, because the shield portion 100 is turned inside-out into the main portion 80, the surface treatments (e.g., coatings or laminates) are presented toward the inflator 24 and directly receive inflation fluid flow from the inflator.

From the above description of the invention, those skilled in the art will perceive improvements, changes and modifications. For example, the shield portion construction of the present invention may be implemented in protection devices other than inflatable curtains, such as driver frontal air bags, passenger frontal air bags, side air bags, and inflatable knee bolsters. Such improvements, changes and modifications within the skill of the art are intended to be covered by the appended claims.

Having described the invention, the following is claimed:

1. An inflatable vehicle occupant protection device comprising:
a main portion defining an inflatable volume; and
a shield portion defining a shield chamber, the inflatable volume and shield chamber being in fluid communication with each other;
the shield portion being turned inside-out, positioned in the inflatable volume, and configured to receive inflation fluid from an inflation fluid source, the shield portion being further configured to rupture and release inflation fluid into the inflatable volume of the main portion.

2. The inflatable vehicle occupant protection device recited in claim 1, wherein the protection device has a one piece woven construction in which the main portion and shield portion are woven as a single piece of material.

3. The inflatable vehicle occupant protection device recited in claim 1, further comprising a neck portion that connects the main portion and shield portion and provides fluid communication between the inflatable volume and the shield chamber.

4. The inflatable vehicle occupant protection device recited in claim 3, wherein the shield portion is turned inside-out through the neck portion.

5. The inflatable vehicle occupant protection device recited in claim 4, wherein the neck portion defines a connection port for receiving inflation fluid for inflating the protection device.

6. The inflatable vehicle occupant protection device recited in claim 1, wherein the shield chamber receives inflation fluid initially directed into the protection device.

7. The inflatable vehicle occupant protection device recited in claim 1, wherein the shield portion comprises tear seams rupturable in response to inflation fluid directed into the shield chamber.

8. The inflatable vehicle occupant protection device recited in claim 1, further comprising a surface treatment applied on an outer surface of the protection device, the surface treatment covering an inner surface of the shield portion when the shield portion is turned inside-out and positioned in the main portion.

9. The inflatable vehicle occupant protection device recited in claim 1, wherein the main portion and shield portion define a single closed volume prior to the shield portion being turned inside-out into the main portion.

10. The inflatable vehicle occupant protection device recited in claim 1, wherein the protection device comprises an inflatable curtain inflatable away from a roof of a vehicle between the side structure of the vehicle and a vehicle occupant.

11. An apparatus for helping to protect an occupant of a vehicle having a side structure and a roof, the apparatus comprising:
an inflatable vehicle occupant protection device being inflatable away from the vehicle roof between the side structure of the vehicle and a vehicle occupant, the protection device comprising:
a main portion defining an inflatable volume; and
a shield portion defining a shield chamber, the inflatable volume and shield chamber being in fluid communication with each other;
the shield portion being turned inside-out, positioned in the inflatable volume, and configured to receive inflation fluid from an inflation fluid source, the shield portion receiving and helping to absorb forces from the initial discharge of inflation fluid into the protection device.

12. The apparatus recited in claim 11, wherein the shield portion is configured to rupture to release inflation fluid into the inflatable volume of the main portion.

13. The inflatable vehicle occupant protection device recited in claim 11, wherein the protection device has a one piece woven construction in which the main portion and shield portion are woven as a single piece of material.

14. The inflatable vehicle occupant protection device recited in claim 11, further comprising a connection port for receiving inflation fluid for inflating the protection device, the connection port being defined where the shield portion is turned inside-out into the main portion.

15. The inflatable vehicle occupant protection device recited in claim 14, further comprising an inflator for providing inflation fluid for inflating the protection device, the connection port being connectable to the inflator.

16. The inflatable vehicle occupant protection device recited in claim 11, wherein the shield portion comprises tear seams rupturable in response to inflation fluid directed into the shield chamber.

17. The inflatable vehicle occupant protection device recited in claim 11, further comprising a surface treatment applied on an outer surface of the protection device, the surface treatment covering an inner surface of the shield portion when the shield portion is turned inside-out and positioned in the main portion.

18. The inflatable vehicle occupant protection device recited in claim 11, wherein the main portion and shield portion define a single closed volume prior to the shield portion being turned inside-out into the main portion.

19. A one piece woven inflatable vehicle occupant protection device comprising:
a main portion defining an inflatable volume;
a shield portion defining a shield chamber; and
a neck portion providing fluid communication between the inflatable volume and the shield chamber;
the shield portion being turned inside-out through the neck portion and positioned in the inflatable volume, the shield portion being configured to receive inflation fluid from an inflation fluid source and being further configured to rupture and release inflation fluid into the inflatable volume of the main portion.
